(19) United States
(12) Patent Application Publication
(10) Pub. No.: US 2025/0138270 A1
(43) Pub. Date: May 1, 2025

(54) ROTATIONAL LENS ASSEMBLY FOR INCREASED POSITIONAL ACCURACY

(71) Applicant: GOOGLE LLC, Mountain View, CA (US)

(72) Inventors: Daniel Adema, Kitchener (CA); Daniel J. Effinger, Squamish (CA); Nabila Zaman, Cambridge (CA)

(21) Appl. No.: 18/921,489

(22) Filed: Oct. 21, 2024

Related U.S. Application Data
(60) Provisional application No. 63/593,047, filed on Oct. 25, 2023.

(51) Int. Cl. G02B 7/02; G02B 27/01

(52) U.S. Cl. CPC G02B 7/022; G02B 27/0172; G02B 2027/0178

(57) ABSTRACT

A rotational lens assembly reduces the size of a gap between a lens and a frame of an optical light engine projector assembly. The lens includes a thread structure arranged around the outside edge of the lens. The thread structure allows the lens to align and lock within the optical assembly via at least a partial rotation of the lens. In addition, the rotation of the lens during assembly results in a relatively small gap between the lens and the frame. The smaller gap, in turn allows the other components of the optical assembly to be manufactured with lower tolerances for variation, improving the overall performance of the optical assembly.

### BACKGROUND

Devices using an optical assembly, such as head-wearable displays (HWDs), can employ any of a number of different techniques to connect a lens to the optical assembly. For example, some devices employ an adhesive to connect the lens to the assembly, while others include mechanical components, such as spacers and/or shoulders in the lens tube (i.e., an elongated tube used to mount optical components include lenses and filters). Each of the aforementioned techniques requires a gap between the lens and the optical assembly for proper lens positioning. In other words, due to variations in the manufacture of the components of the optical assembly, a gap is required to ensure that the lens can be placed within the optical assembly. However, the presence of the gap can negatively affect optical performance. For example, the gap can result in small movements of the lens, causing undesired refraction or reflection of display light.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a display system housing a projector system configured to project images toward the eye of a user in accordance with some embodiments.

FIG. 2 is a diagram of a lens with a thread in accordance with some embodiments.

FIG. 3 is a diagram of the lens in FIG. 2 inserted within a lens barrel in accordance with some embodiments.

FIG. 4 is a diagram of the lens in FIG. 3 that has been rotated within the lens barrel in accordance with some embodiments.

FIG. 5 is a diagram of a lens with a thread inserted within a lens barrel in accordance with some embodiments.

FIG. 6 is a diagram of the lens in FIG. 5 that has been rotated within the lens barrel in accordance with some embodiments.

FIG. 7 is a diagram of a lens with a thread having a continuous thread-form and inserted within a lens barrel that has been prevented from further axial movement by a locking member in accordance with some embodiments.

FIG. 8 is a diagram of a lens with a thread that is insertable into a lens barrel in accordance with some embodiments.

FIG. 9 is a diagram of a lens with a thread having a discontinuous thread-form in accordance with some embodiments.

FIG. 10 is a diagram of a first facet of the thread of FIG. 9 in accordance with some embodiments.

FIG. 11 is a diagram of a second facet of the thread of FIG. 9 in accordance with some embodiments.

FIG. 12 is a diagram of a lens barrel in accordance with some embodiments.

FIG. 13 is a diagram of an optical light engine projector assembly having a plurality of lenses disposed therein in accordance with some embodiments.

### DETAILED DESCRIPTION

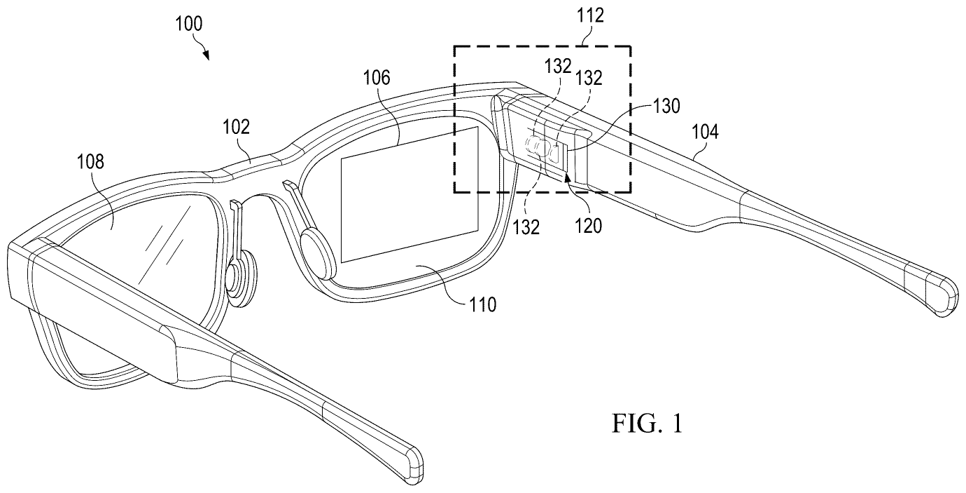

FIGS. 1-13 illustrate techniques for reducing the size of a gap between a lens and a frame of an optical light engine projector assembly (hereinafter, optical assembly, for brevity). The lens includes a thread structure arranged around the outside edge of the lens. The thread structure allows the lens to align and lock within the optical assembly via at least a partial rotation of the lens. In addition, the rotation of the lens during assembly results in a relatively small gap between the lens and the frame. The smaller gap, in turn allows the other components of the optical assembly to be manufactured with lower tolerances for variation, improving the overall performance of the optical assembly.

To illustrate, in a conventional optical assembly, the lens is inserted into the optical assembly through a snap-fit or using an adhesive to strengthen the connection. However, these techniques result in a relatively large gap between the lens and the optical assembly. The gap ensures that the lens will fit within the optical assembly regardless of any variations (e.g. variations in size) in the components of the optical assembly that could affect mounting of the lens. However, the gap also causes unstable positioning of the lens, such that the lens is prone to undesirable variability in the assembly process. Furthermore, the lens has a higher chance of detaching from the optical assembly due to the gap. Using the techniques described herein, a lens includes a thread structure that facilitates placement of the lens into the optical assembly via rotation of the lens. This rotation of the lens reduces the gap between the lens and the optical assembly and reduces or eliminates unwanted movement. For example, in some cases the thread connects to a corresponding thread within an aperture of the optical assembly, such as, for example, a lens barrel. By rotating the lens within the optical assembly, the lens thread connects to the corresponding barrel thread and reduces the gap by causing material of the lens to fill the gap.

In some embodiments, the thread is shaped to center the lens in the optical assembly. For example, in some embodiments the shape of the thread that centers the lens in the optical assembly is a tapered thread, such that a first portion of the thread disposed on an edge of the lens tapers toward a second portion of the thread at a distance away from the lens. Moreover, in some embodiments, the thread is discontinuous along the lens to prevent the occurrence of total internal reflection (TIR). That is, by separating the thread into individual distinct portions, incident light (e.g., stray light) can be prevented from TIR by allowing the stray light to escape these portions. Specifically, by separating the thread into individual distinct portions, the angle of incidence of the incident light in the lens will be less than a critical angle (i.e., an incident angle that produces an angle of refraction of ninety degrees (90°)). Comparatively, a continuous thread-form is not able to break TIR because the thread is contiguous along the entire length of the thread. Thus, variations in direction of the thread on the continuous thread-form, such that the angle of incidence is less than the critical angle is not preferable without causing irregular transitions along the length of the thread.

Display systems such as head-wearable displays (HWDs) include lenses that facilitate viewing an environment. An optical assembly or light engine generates display light, which is emitted through a frame into at least one lens of the HWD. Variations or unwanted movement in the lens position can cause distortion or errors in the displayed image. In particular, the display light that is emitted into the lens reflects off each interior surface of the lens and the thread and becomes stray light that is unintended and results in distortion or errors in the display light. Rotating the thread within the HWD ensures the position of the lens does not change and this increased stability of the lens improves the quality of the display light. Further, by using particular shapes of the thread, the impact of the stray light is greatly diminished or eliminated.

In some embodiments, a detent or a pin added to connection points between the lens and the optical assembly increases stability of the lens further. Additionally, adjusting a thread to include a trapezoidal or Acme thread facilitates movement of the lens in the optical assembly in an axial direction in response to rotation of the lens within the optical assembly. However, these aspects are not mutually exclusive. In other words, different modifications of the thread may be combined and added to the lens and/or the optical assembly ensure positioning of the lens remains constant and prevents unwanted movement. Such modifications can be added to the lens that connects to the optical assembly during installation of the lens on the optical assembly. Alternatively, the optical assembly may include additional features that contact or receive the lens. Thus, the experience of the user viewing, for example, the display light through the lens is improved by eliminating movement of the lens or stray light within the lens.

FIG. 1 illustrates a display system 100 having a frame 102 that includes a first arm 104, which houses a projection system configured to project display light representative of images toward an eye of a user, such that the user perceives the projected images as being displayed in a field of view (FOV) area 106 of a display at a first lens 108 and/or a second lens 110. In the depicted embodiment, the display system 100 is a head-wearable display (HWD) that includes the frame 102 configured to be worn on the head of a user and has a general shape and appearance of a pair of eyeglasses. The frame 102 contains or otherwise includes various components to facilitate the projection of such images toward the eye of the user, such as a light engine 120, a projector, an optical scanner, and a waveguide. It will be appreciated that use of light engine 120 is used interchangeably with optical assembly 120. In some embodiments, the frame 102 further includes various sensors, such as one or more front-facing cameras, rear-facing cameras, other light sensors, motion sensors, accelerometers, and the like. The frame 102 further can include one or more radio frequency (RF) interfaces or other wireless interfaces, such as a Bluetooth® interface, a Wi-Fi interface, and the like. Further, in some embodiments, the frame 102 further includes one or more batteries or other portable power sources for supplying power to the electrical components of the display system 100. In some embodiments, some or all of these components of the display system 100 are fully or partially contained within an inner volume of the frame 102, such as within the arm 104 in a region 112 of the frame 102. It should be noted that while an example form factor is depicted, it will be appreciated that in other embodiments the display system 100 may have a different shape and appearance from the eyeglasses frame depicted in FIG. 1.

In the depicted embodiment of FIG. 1, the optical assembly 120 further includes a lens barrel 130 and a plurality of optic lenses 132 (hereinafter, lenses 132, for brevity). The lens barrel 130 receives, stores, and houses at least one of the plurality of lenses 132. In other words, the plurality of lenses 132 detachably connects within the lens barrel 130. In some embodiments, as will be described below, the lens barrel 130 includes circuitry and/or electrical components that receive the display light that is emitted into the plurality of lenses 132. In some embodiments, the lens barrel 130 includes a threaded aperture that receives and connects to a thread disposed on, for example, the plurality of lenses 132. Furthermore, in other embodiments, the lens barrel 130 includes at least one locking member that increases stability of the plurality of lenses 132 in response to the at least one of the plurality of lenses 132 contacting the at least one locking member within the lens barrel 130. For example, the at least one locking member contacting at least one of the plurality of lenses 132 restricts or prevents movement of the plurality of lenses 132 in an axial direction while being inserted within the lens barrel 130.

The first lens 108 and/or the second lens 110 are used by the display system 100 to provide an augmented reality (AR) display in which rendered graphical content can be superimposed over or otherwise provided in conjunction with a real-world view as perceived by the user through the first lens 108 and/or the second lens 110. For example, display light used to form a perceptible image or series of images may be projected by a projector of the display system 100 onto the eye of the user via a series of optical elements, such as a waveguide disposed at least partially within or otherwise connected to the first lens 108 and/or the second lens 110, one or more scan mirrors, and one or more optical relays. Thus, in some embodiments, the first lens 108 and/or the second lens 110 includes at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, the first lens 108 and/or the second lens 110 are sufficiently transparent to allow a user to see through the lens elements to provide a FOV of the user's real-world environment such that the image appears superimposed over at least a portion of the real-world environment.

In some embodiments, the optical assembly 120 is a digital light processing-based projector, a microdisplay, scanning laser projector, or any combination of a modulative light source. For example, according to some embodiments, the optical assembly 120 includes a laser or one or more LEDs and a dynamic reflector mechanism such as one or more dynamic scanners or digital light processors. In some embodiments, the optical assembly 120 includes multiple laser diodes (e.g., a red laser diode, a green laser diode, and/or a blue laser diode) and at least one scan mirror (e.g., two one-dimensional scan mirrors, which may be MEMS-based or piezo-based). The optical assembly 120 is communicatively coupled to the controller and a non-transitory processor-readable storage medium or a memory that stores processor-executable instructions and other data that, when executed by the controller, cause the controller to control the operation of the optical assembly 120. In some embodiments, the controller controls a scan area size and scan area location for the optical assembly 120 and is communicatively coupled to a processor (not shown) that generates content to be displayed at the display system 100. The optical assembly 120 scans light over a variable area, designated the FOV area 106, of the display system 100. The scan area size corresponds to the size of the FOV area 106 and the scan area location corresponds to a region of the first lens 108 and/or the second lens 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

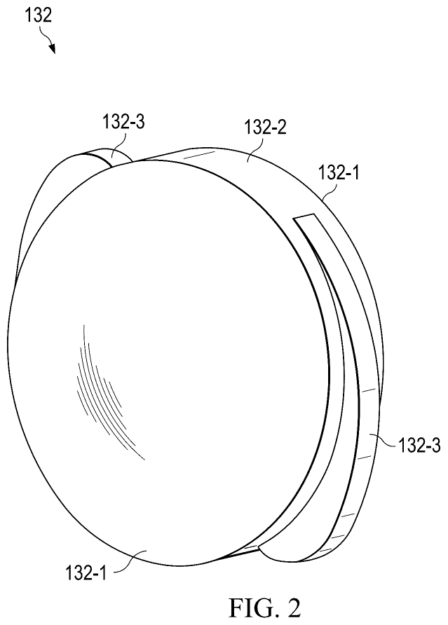

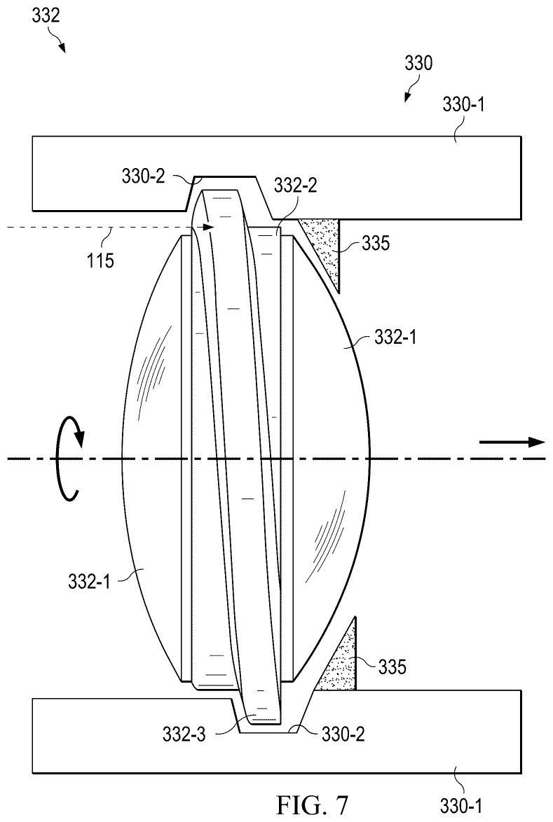

FIG. 2 illustrates a diagram of a lens 132 (i.e., a lens apparatus) with a thread in accordance with some embodiments. In the depicted example, the lens 132 includes a lens body 132-1, an edge 132-2, and a plurality of threads 132-3. The lens body 132-1 is used by the optical assembly 120 to provide the AR display for rendered graphical content. Moreover, in some embodiments, the lens body 132-1 is used to provide corrective or therapeutic adjustment for the eye of the user. For example, the lens body 132-1 treats refractive errors in the eye of the user that causes near-sightedness, far-sightedness, and the like. The lens body 132-1 has different sizes (e.g., volume) and shapes (e.g., convex or concave with respect to a plane). In some embodiments, as illustrated in FIG. 7 for example, a first side of the lens body 132-1 is convex and a second side of the lens body 132-1 opposite the first side of the lens body 132-1 is also convex. In another embodiment, the first side of the lens body 132-1 is convex and the second side of the lens body 132-1 is concave. In another embodiment, the first side of the lens body 132-1 is concave and the second side of the lens body 132-1 is concave. In another embodiment, the first side of the lens body 132-1 is concave and the second side of the lens body 132-1 is convex. The different shapes of the lens body 132-1 have different optical characteristics, such as different refractive and/or reflective behavior of light. Stated differently, the lens body 132-1 will refract and/or reflect light on a convex surface differently from a concave surface. It is important to control the refraction and/or reflection of light within the lens body 132-1 in order to control how light moves through the lens body 132-1 and is received, such as at the eye of the user, including any images presented on the lens 132-1. In each of the aforementioned examples, the shape of the lens body 132-1 is based on the optical assembly 120.

The edge 132-2 is an edge around the lens body 132-1. Specifically, the edge 132-2 is a surface (e.g., a cylindrical surface in the depicted example) disposed between a first side of the lens body 132-1 and a second side of the lens body 132-1 opposite to the first side. In other words, the first side of the lens body 132-1 is disposed on a first side of the edge 132-2 and a second side of the lens body 132-1 is disposed on a second side of the edge 132-2 opposite to the first side of the edge 132-2. The edge 132-2 contacts a lens barrel 130 in response to rotating the lens body 132-1 within the lens barrel 130. In some embodiments, the edge 132-2 is at least partially transparent and receives the display light 115 from the lens barrel 130 while the edge 132-2 is connected to the lens barrel 130. Accordingly, the display light 115 is transferred through the edge 132-2 prior to entering the lens body 132-1.

In the depicted example, the plurality of threads 132-3 (also referred to as a cam profile 132-3) is disposed on the edge 132-2. Each of the plurality of threads 132-3 has a specific shape and/or size that will correspond to the lens barrel 130. More specifically, as will be described below, the shape and/or the size of the plurality of threads 132-3 are based on the size and/or the shape of the lens barrel 130, such that the lens barrel 130 receive and connect to the lens body 132-1 in response to connecting to the plurality of threads 132-3. In other words, the plurality of threads 132-3 forms connection points of the lens body 132-1 to the lens barrel 130. The plurality of threads 132-3 moves and interconnects with a thread within the lens barrel 130 in response to at least partially rotating the lens body 132-1 and/or the edge 132-2 while the lens body 132-1 is disposed in at least one of the lens barrel 130, such that the cam profile 132-3 aligns to create a preload (i.e., match of the cam profile 132-3 with the lens barrel 130) to lock the lens body 132-1 in place. Each of the plurality of threads 132-3 are connected (i.e., mounted, inserted, installed) within the lens barrel 130. Thus, the plurality of threads 132-3 fits into the lens barrel 130. Also, the cam profile 132-3 includes grooves and/or interlocking threads that connect to at least a portion of the lens barrel 130, such that the cam profile 132-3 locks to the lens barrel 130 in response to a partial rotation of the cam profile 132-3 within the lens barrel 130. Thus, in some embodiments the cam profile 132-3 locks to the lens barrel 130 in response to the cam profile being rotated less than 360 degrees. For example, in some embodiments the cam profile 132-3 locks to the lens barrel 130 in response to a rotation of 270 degrees or less. In other embodiments the cam profile 132-3 locks to the lens barrel 130 in response to a rotation of 180 degrees or less.

It will be appreciated that the description of one of the plurality of lenses 132 herein is applicable to any of the plurality of lenses 132. Specifically, in some embodiments, each of the plurality of lenses 132 includes similar components as one of the plurality of lenses 132. Alternatively, in some embodiments, the at least one of the plurality of other lenses 132 is constructed with additional components than the lens 132, described above, or fewer components than the lens 132.

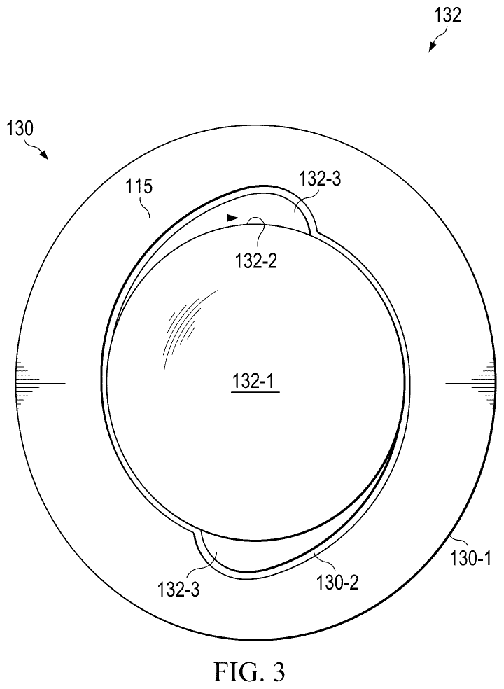

FIG. 3 illustrates a diagram of the lens 132 in FIG. 2 inserted within the lens barrel 130 in accordance with some embodiments. In the depicted example, the lens barrel 130 includes a rim 130-1 and a threaded hole 130-2 (a.k.a., a threaded aperture). The rim 130-1 is an outer edge or boundary of the frame 102 around the lens 132. The rim 130-1 has a shape and/or a size corresponding to the shape and/or the size of the lens body 132-1 and/or the edge 132-2. Therefore, the rim 130-1 connects to the lens body 132-1 and/or the edge 132-2 in response to receiving the lens body 132-1 and/or the edge 132-2.

The threaded hole 130-2 is a hole disposed on an interior of the rim 130-1. Moreover, the threaded hole 130-2 includes a thread at least partially extending from a first side of the threaded hole 130-2 to a second side of the threaded hole 130-2 opposite to the first side. In other words, a depth of the thread within the threaded hole 130-2 is based on specifications for installation, orientation, or placement of the lens body 132-1 within the threaded hole 130-2. In a first example, the lens body 132-1 disposed at an edge of the rim 130-1 is based on the thread of the threaded hole 130-2 having a shallow depth (e.g., a depth proximal to entry of the lens body 132-1 in the threaded hole 130-2). In a second example, the lens body 132-1 disposed at a center of the rim 130-1 with respect to a first side of the rim 130-1 and a second side of the rim 130-1 opposite to the first side, is based on the thread of the threaded hole 130-2 having an intermediate depth (e.g., a depth between shallow and full). In a third example, the lens body 132-1 disposed within an entire width of the rim 130-1 (i.e., from the first side of the rim 130-1 to the second side of the rim 130-1) is based on the thread of the threaded hole 130-2 having a full depth (e.g., a depth distal from entry of the lens body 132-1 in the threaded hole 130-2, a distance furthest from entry in the threaded hole 130-2). The threaded hole 130-2 has a shape and/or a size corresponding to the shape and/or the size of the lens body 132-1 and/or the edge 132-2. Moreover, the threaded hole 130-2 receives and connects to the plurality of threads 132-3. Thus, each of the plurality of threads 132-3 connects and interconnects with corresponding threads within the threaded hole 130-2.

After the lens 132 has been inserted into the threaded hole 130-2, there is a gap between the lens 132 and the threaded hole 130-2. In other words, the size of the threaded hole 130-2 is slightly greater than the size of the lens 132. As such, a boundary comprising an entire outer edge of the lens 132 is surrounded by the threaded hole 130-2 in response to inserting the lens 132 within the threaded hole 130-2. Furthermore, in some embodiments, each surface of the lens 132 is disposed away from (i.e., does not touch) the thread within the threaded hole 130-2 and/or the rim 130-1.

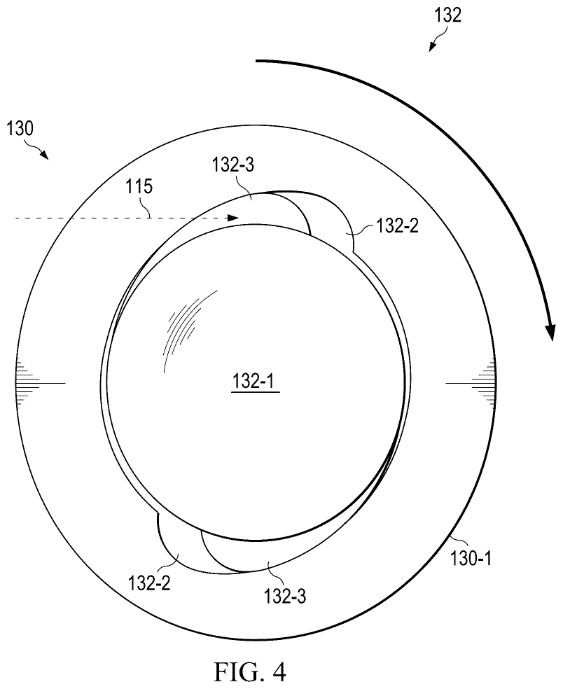

FIG. 4 illustrates a diagram of the lens 132 that has been rotated within the lens barrel 130 in accordance with some embodiments. Subsequent to insertion of the lens 132 within the threaded hole 130-2, the lens 132 is rotated within the threaded hole 130-2 in an axial direction (i.e., perpendicular with respect to a plane of the lens barrel 130). Each of the plurality of threads 132-3 moves and interconnects with the thread within the threaded hole 130-2 in response to rotating the lens body 132-1 and/or the edge 132-2 while the lens body 132-1 is disposed in the threaded hole 130-2. Thus, for example, the gap is eliminated between the lens body 132-1 and the threaded hole 130-2 in response to rotating the lens body 132-1 in a first rotational direction (i.e., clockwise) or a second rotational direction (i.e., counterclockwise). Furthermore, the lens body 132-1 aligns and locks into place within the threaded hole 130-2 in response to rotation of the lens body 132-1 within the threaded hole 130-2. As such, the lens body 132-1, the edge 132-2, and/or the plurality of threads 132-3 eliminate the gap between the lens body 132-1 and the threaded hole 130-2 in response to rotating the lens body 132-1 in the threaded hole 130-2. Accordingly, material of the lens body 132-1 and/or the edge 132-2 fill the gap and fully eliminates the gap. However, in some embodiments, the material of the lens body 132-1 and/or the edge 132-2 only partially eliminates the gap. Also, the gap may be partially filled based on a degree of rotation of the lens body 132-1 in the threaded hole 130-2. Conversely, rotating in the opposite direction with respect to the direction used to interconnect the plurality of threads 132-3 with the thread within the threaded hole 130-2, facilitates extraction of the lens body 132-1 and/or the plurality of threads 132-3 from the thread hole 130-2.

Accordingly, by rotating the lens 132 within the threaded hole 130-2, assembly of the lens 132 within the rim 130-1 and/or the frame 102 results in tighter placement tolerance of the lens 132 than a traditional connection of a lens using an adhesive or snap-fit. Specifically, application of rotation of the lens body 132-1 to connect the plurality of threads 132-3 to the threaded hole 130-2 ensures stable placement of the lens 132 within the threaded hole 130-2 and the frame 102.

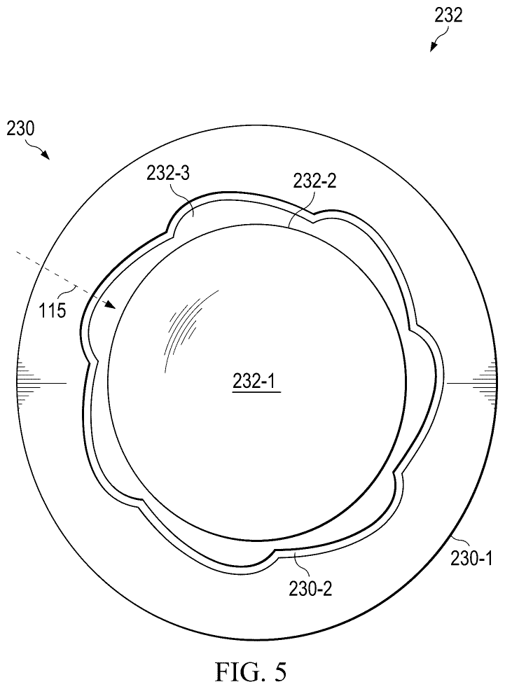

FIG. 5 illustrates a diagram of a lens 232 with a thread inserted within a lens barrel 230 in accordance with some embodiments. The lens 232 may implement or be implemented by aspects of the lens 132 as described with reference to FIGS. 1 through 4. Similarly, the lens barrel 230 may implement or be implemented by aspects of the lens barrel 130 as described with reference to FIGS. 3 and 4. The lens 232 includes a lens body 232-1, an edge 232-2, and a thread 232-3. The lens barrel 230 includes a rim 230-1 and a threaded hole 230-2 (a.k.a., a threaded aperture). Unlike the plurality of threads 132-3, the thread 232-3 is a single thread disposed on the edge 232-2. The single thread of the thread 232-3 is referred to as a continuous thread-form. In other words, the thread 232-3 is contiguous across an entire length of the thread. The thread 232-3 has a specific shape and/or size that corresponds to the lens barrel 230. More specifically, as will be described below, the shape and/or the size of the thread 232-3 is based on the size and/or the shape of the lens barrel 230, such that the lens barrel 230 receives and connects to the lens body 232-1 in response to connecting to the thread 232-3. In other words, the thread 232-3 is a connection point of the lens body 232-1 to the lens barrel 230. The thread 232-3 has a greater surface area than a surface area of the plurality of threads 132-3 due to the thread 232-3 having the continuous thread-form. Specifically, in the depicted example, the thread 232-3 extends over an entire circumference of the lens body 232-1 and/or the edge 232-2.

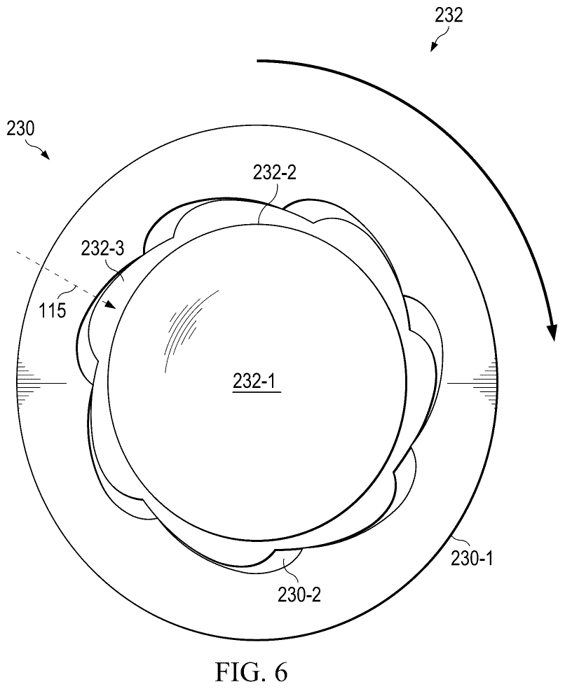

FIG. 6 illustrates a diagram of the lens 232 that has been rotated within the lens barrel 230 in accordance with some embodiments. Similar to the implementation of the lens 132 in FIG. 4, the lens 232 is rotated within the threaded hole 230-2 in an axial direction (i.e., perpendicular with respect to a plane of the lens barrel 230). The thread 232-3 moves and interconnects with the thread within the threaded hole 230-2 in response to rotating the lens body 232-1 and/or the edge 232-2 while the lens body 232-1 is disposed in the threaded hole 230-2. Therefore, the gap is substantially eliminated between the lens body 232-1 and the threaded hole 230-2 in response to rotating the lens body 232-1 in a first rotational direction (i.e., clockwise) or a second rotational direction (i.e., counterclockwise). Accordingly, material of the lens body 232-1 and/or the edge 232-2 fills the gap and substantially eliminates the gap.

FIG. 7 illustrates a diagram of a lens 332 with a thread having a continuous thread-form and inserted within a lens barrel 330 that has been prevented further axial movement by a locking member in accordance with some embodiments. The lens 332 may implement or be implemented by aspects of the lens 132 and 232 as described with reference to FIGS. 1 through 6. Similarly, the lens barrel 330 may implement or be implemented by aspects of the lens barrel 130 and 230 as described with reference to FIGS. 3 through 6. The lens 332 includes a lens body 332-1, an edge 332-2, and a thread 332-3. The lens barrel 330 includes a rim 330-1 and a threaded hole 330-2 (a.k.a., a threaded aperture). Like the thread 232-3, the thread 332-3 is a single thread disposed on the edge 332-2. The single thread of the thread 332-3 is a continuous thread-form. In other words, the thread 332-3 is contiguous across an entire length of the thread. Thus, the thread 332-3 extends over an entire circumference of the lens body 332-1 and/or the edge 332-2.

In the depicted example, the lens 332 is rotated within the threaded hole 330-2 in an axial direction (i.e., perpendicular with respect to a plane of the lens barrel 330) while being inserted within the lens barrel 330. The thread 332-3 moves and interconnects with the thread within the threaded hole 330-2 in response to rotating the lens body 332-1 and/or the edge 332-2 while the lens body 332-1 is disposed in the threaded hole 330-2. Therefore, the gap is substantially eliminated between the lens body 332-1 and the threaded hole 330-2 in response to rotating the lens body 332-1 in a first rotational direction (i.e., clockwise) or a second rotational direction (i.e., counterclockwise). Accordingly, material of the lens body 332-1 and/or the edge 332-2 fills the gap and substantially eliminates the gap.

Also, the thread 332-3 has a trapezoidal or Acme thread. As such, the thread 332-3 is tapered. Specifically, the thread 332-3 tapers (i.e., narrows) from a position on the lens body 332-1 to a distance away from the lens body 332-1. In other words, for example, a width of the thread 332-3 as disposed on the lens body 332-1 is greater than the width of the thread 332-3 at a portion of the thread 332-3 disposed at a distance furthest from the lens body 332-1. The trapezoidal or Acme thread moves the lens body 332-1 in the axial direction in response to rotation within the threaded hole 330-2. Also, the taper of the thread 332-3 provides a centering bias within the threaded hole 330-2. Accordingly, the lens body 332-1 remains centered during movement within the threaded hole 330-2.

Furthermore, in the depicted example, a plurality of locking members 335 are disposed on the rim 330-1. The plurality of locking members 335 improve fit of the lens body 332-1 within the threaded hole 330-2 where the thread 332-3 is tapered. In some embodiments, each of the plurality of locking members 335 include a detent, a pin, a snap, an adhesive (e.g., tape, glue), a clamp, and the like. Each of the plurality of locking members 335 detachably connect to the lens body 332-1, the edge 332-2, and/or the thread 332-3 in response to rotating the lens body 332-1 and/or the edge 332-2 while the lens body 332-1 is disposed in the threaded hole 330-2. As such, each of the plurality of locking members 335 prevent movement of the lens 332 beyond the plurality of locking members 335 based on a position and/or a configuration of each of the plurality of locking members 335. For example, the detent prevents movement of the lens 332 from moving further into the threaded hole 330-2 after the lens 332 contacts the detent. However, an application of force, such as pushing, pulling, and/or rotating by a user over a resistance threshold (i.e., resistance force of the detent that prevents movement) of the detent to allow continued movement of the lens 332 further into the threaded hole 330-2. Alternatively, the pin, the snap, and/or the clamp provide complete obstruction to prevent movement of the lens 332 in response to contact of the lens 332 with the pin, the snap, and/or the clamp. In other words, each of the plurality of locking members 335 operate as a mechanical lock that exert a frictional force.

In other embodiments, each of the plurality of locking members 335 include a magnet. Each of the plurality of locking members 335 magnetically connect to a corresponding magnet disposed on the lens body 332-1, the edge 332-2, and/or the thread 332-3 in response to rotating the lens body 332-1 and/or the edge 332-2 while the lens body 332-1 is disposed in the threaded hole 330-2. Each of the plurality of locking members 335 magnetically prevent movement of the lens 332 beyond the plurality of locking members 335. For example, the magnet prevents movement of the lens 332 from moving further into the threaded hole 330-2 after the magnet on the lens 332 is within a magnetic attraction threshold (i.e., minimum distance of the magnet on the lens to exert a magnetic force on the plurality of locking members 335) of the plurality of locking members 335. However, an application of force, such as pushing, pulling, and/or rotating by a user over the magnetic attraction threshold to allow continued movement of the lens 332 further into the threaded hole 330-2.

Each of the plurality of locking members 335 are disposed at a predetermined position on the rim 330-1 and/or within the threaded hole 330-2. Specifically, the plurality of locking members 335 are positioned based on a centration threshold (a.k.a., optical centration, the mechanical axis defined by an outer edge of the lens 332 is coincident with the optical axis as determined by a line through a center of the curvature of each side of the lens body 332-1) and a radial orientation threshold (i.e., a direction along radius, perpendicular to a curved direction). In some embodiments, the position of the plurality of locking members 335 are implemented where the lens 132, the lens 232, and/or the lens 332 are not symmetric along the optical axis. In such cases, the plurality of locking members 335 are disposed on the predetermined position along a radial position of the lens 132, the lens 232, and/or the lens 332 to ensure the centration threshold and the radial orientation threshold provide centering of the lens 132, the lens 232, and/or the lens 332. Moreover, the plurality of locking members 335 ensure correct positioning of the lens 132, the lens 232, and/or the lens 332 and prevent slippage or unwanted movement.

Any number (i.e., one, two, three, four, etc.) of the plurality of locking members 335 is applicable to the lens 132, the lens 232, and/or the lens 332. Additionally, in some embodiments, the plurality of locking members 335 are disposed on the lens barrel 130, the lens barrel 230, and/or the lens barrel 330 based on assembly of the respective components. For example, a locking member 335 as a detent, a pin, and/or a snap that is disposed on the lens body 332-1, the edge 332-2, and/or the thread 332-3 prevents further movement of the lens body 332-1 in the axial direction during rotation of the lens body 332-1 in response to contact of the locking member 335 against the rim 330-1. In other embodiments, the locking member 335 as a magnet that is disposed on the lens body 332-1, the edge 332-2, and/or the thread 332-3 magnetically prevents further movement of the lens body 332-1 in the axial direction during rotation of the lens body 332-1 in response to the locking member 335 moving within the magnetic attraction threshold of a corresponding magnet on the rim 330-1 and/or within the threaded hole 330-2.

FIG. 8 illustrates a diagram of a lens 432 with a thread that is insertable into a lens barrel 430 in accordance with some embodiments. The lens 432 may implement or be implemented by aspects of the lens 132, 232, and 332 as described with reference to FIGS. 1 through 7. Similarly, the lens barrel 430 may implement or be implemented by aspects of the lens barrel 130, 230, and 330 as described with reference to FIGS. 3 through 7. The lens 432 includes a lens body 432-1, an edge 432-2, and a plurality of threads 432-3 (a.k.a., a cam profile 432-3). The lens barrel 430 includes a rim 430-1 and a threaded hole 430-2 (a.k.a., a threaded aperture). The threaded hole 430-2 has a thread that extends from a first side of the rim 430-2 to a second side of the rim 430-1 opposite to the first side. As such, the thread within the threaded hole 430-2 spans an entire depth of the threaded hole 430-2.

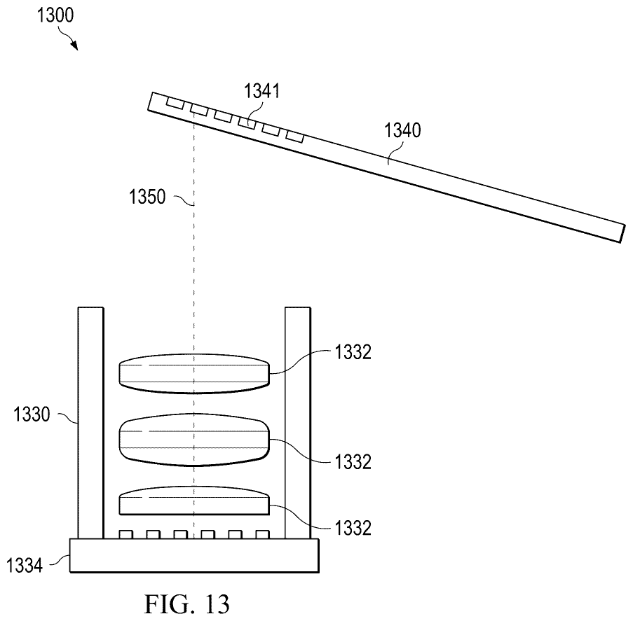

The plurality of threads 432-3 are referred to as a discontinuous thread-form. In other words, the plurality of threads 432-3 are not contiguous across an entire length of the plurality of threads 432-3. Stated differently, each of the plurality of threads 432-3 are separate and distinct from each other. Therefore, the plurality of threads 432-3 are advantageous to a continuous thread-form by facilitating manufacture. Conversely, the continuous thread-form is more complex to manufacture than the discontinuous thread-form. Accordingly, the connection for the lens 432 on the optical assembly is different depending on the thread of the lens 432, such as the optical assembly 1300 illustrated in FIG. 13. The thread 432-3 of the lens 432 is constructed differently to fit within a corresponding connection on the optical assembly 1300. As such, the thread 232-3 and the thread 332-3 would require different connection to the optical assembly 1300 than the plurality of threads 432-3 because the thread 232-3 and the thread 332-3 have the continuous thread-form. By separating the plurality of threads 432-3 into individual distinct portions (i.e., individual thread 432-3), incident light (e.g., stray light) can be prevented from TIR by allowing the stray light to escape these portions. Specifically, by separating the plurality of threads 432-3 into individual distinct portions, the angle of incidence of the incident light in the lens 432 will be less than a critical angle (i.e., an incident angle that produces an angle of refraction of ninety degrees (90°)). Comparatively, the thread 232-3 and the thread 332-3 are not able to break TIR because the thread 232-3 and the thread 332-3 are contiguous along the entire length of the thread. Thus, variations in direction of the thread 232-3 and the thread 332-3, such that the angle of incidence is less than the critical angle is not preferable.

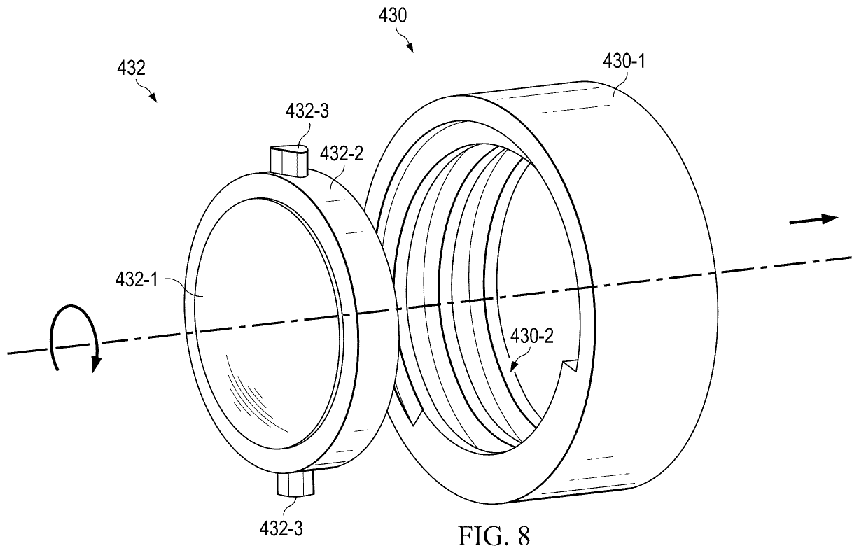

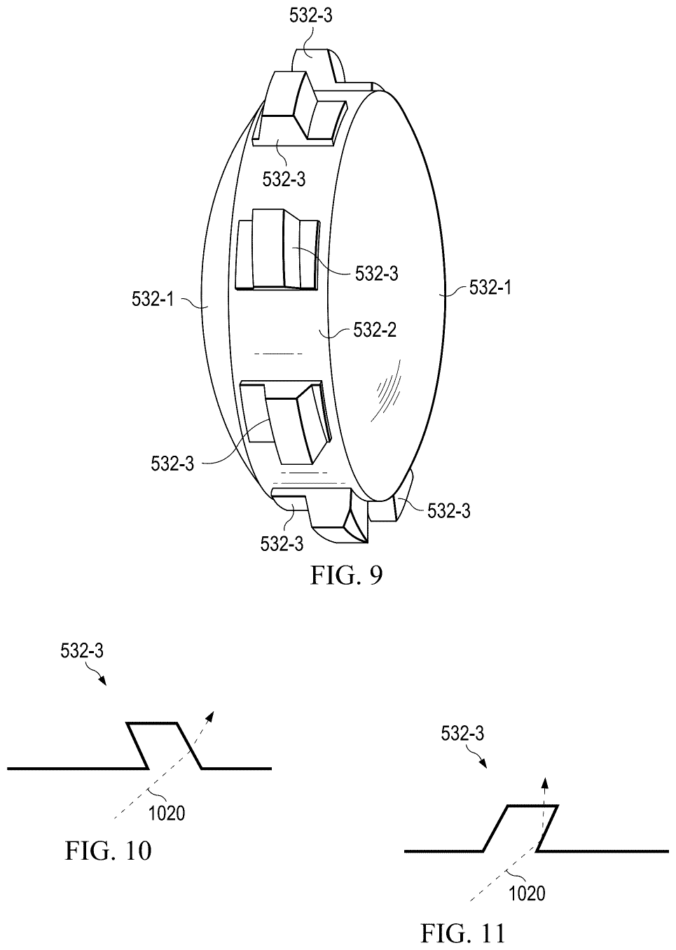

FIG. 9 illustrates a diagram of a lens 532 with a thread having a discontinuous thread-form in accordance with some embodiments. The lens 432532 may implement or be implemented by aspects of the lens 132, 232, 332, and 432 as described with reference to FIGS. 1 through 8. The lens 532 includes a lens body 532-1, an edge 532-2, and a plurality of threads 532-3. Unlike the plurality of threads 132-3 and 432-3, the plurality of threads 532-3 includes a greater number of the plurality of threads 532-3. Furthermore, in the depicted example, each of the plurality of threads 532-3 has a different shape with respect to each other. For example, a first (a.k.a., a first facet) of the plurality of threads 532-3 is oriented toward (i.e., a tip of each of the plurality of threads 532-3 disposed at a distance furthest from the edge 532-2) a first side of the lens body 532-1, a second (a.k.a., a second facet) of the plurality of threads 532-3 is oriented toward a second side of the lens body 532-1 opposite to the first side, and a third (a.k.a., a third facet) of the plurality of threads 532-3 is oriented toward a center between the first side and the second side. Additional threads 532-3 are oriented differently in orientations between the aforementioned threads. For example, a fourth (a.k.a., a fourth facet) of the plurality of threads 532-3 is oriented in a direction between the first of the plurality of threads 532-3 and the third of the plurality of threads 532-3, while a fifth (a.k.a., a fifth facet) of the plurality of threads 532-3 is oriented in another direction between the second of the plurality of threads 532-3 and the third of the plurality of threads 532-3. In other words, each of the plurality of facets of the discontinuous thread-form is disposed differently from each other facet of the plurality of facets with respect to an optical axis (i.e., a perpendicular axis to the plurality of facets).

Each of the plurality of threads 532-3 provides different configurations and redirect stray light differently from each other as will be described further below.

FIG. 10 illustrates a diagram of a first facet of the thread 532-3 in accordance with some embodiments. As described above, the first facet of the plurality of threads 532-3 is oriented toward the first side (i.e., angled to the left) of the lens body 532-1. Moreover, the lens body 532-1 receives the display light through the lens barrel 130, the lens barrel 230, the lens barrel 330, and/or the lens barrel 430 from a light engine. Generally, the display light includes an AR display in which rendered graphical content is displayed on the lens body 532-1. However, the display light received within the lens body 532-1 is redirected within the lens body 532-1 based on the shape of the interior surface of the lens body 532-1 with respect to an exterior environment beyond a boundary of the lens body 532-1. Moreover, the display light that is redirected becomes stray light (i.e., unintended light within the lens body 532-1) in response to being redirected within the lens body 532-1 and is not used to render graphical content. The stray light within the lens body 532-1 creates aberrations, errors, and/or distortions of the graphical content within the lens body 532-1. Therefore, the first facet of the plurality of threads 532-3 is oriented toward the first side of the lens body 532-1 to redirect the stray light to exit through an exterior surface of the lens body 532-1 with respect to the environment surrounding the lens body 532-1 and the first facet.

FIG. 11 illustrates a diagram of a second facet of the thread 532-3 in accordance with some embodiments. As described above, the second facet of the plurality of threads 532-3 is oriented toward the second side (i.e., angled to the right) of the lens body 532-1. Accordingly, the second facet of the plurality of threads 532-3 redirects the stray light to exit differently through the exterior surface of the lens body 532-1 than how the stray light exited through the first facet as illustrated in FIG. 10. As such, each of the facets of the plurality of threads 532-3 redirects the stray light through the thread based on an angle of orientation of each facet.

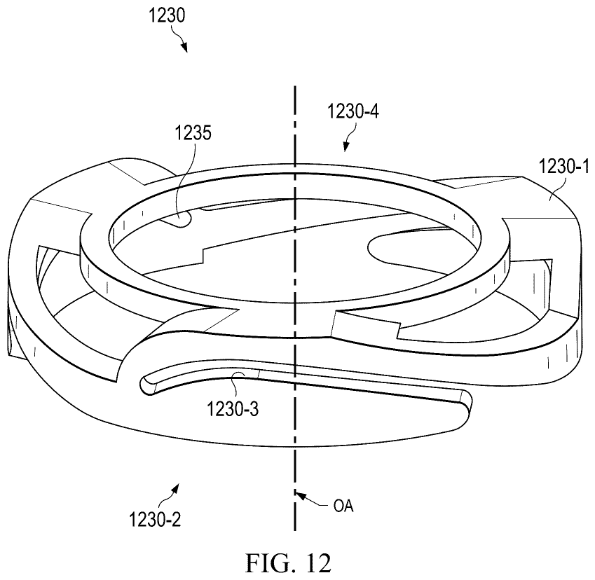

FIG. 12 illustrates a diagram of a lens barrel 1230 in accordance with some embodiments. The lens barrel 1230 may implement or be implemented by aspects of the lens barrel 130, 230, 330, and 430 as described with reference to FIGS. 3 through 8. The lens barrel 1230 includes a rim 1230-1, a threaded hole 1230-2 (a.k.a., a threaded aperture), a plurality of receiving threads 1230-3, and a lens receiving hole 1230-4. In the depicted example, the plurality of receiving threads 1230-3 is disposed on a first side of the rim 1230-1 and a second side of the rim 1230-1 opposite to the first side. However, in other embodiments, there is a single receiving thread 1230-3 or more than two of the plurality of receiving threads 1230-3. Each of the plurality of receiving threads 1230-3 receives, for example, the plurality of threads 132-3 and/or the plurality of threads 432-3. In other embodiments, with a greater number of the plurality of receiving threads 1230-3, the plurality of receiving threads 1230-3 receives the plurality of threads 532-3. Therefore, in some embodiments, a number of the plurality of receiving threads 1230-3 is equivalent or greater than a number of the plurality of threads on a lens.

The lens receiving hole 1230-4 receives at least one side of the lens therethrough. For example, the lens receiving hole 1230-4 receives a first side of the lens body 132-1, the lens body 232-1, the lens body 332-1, the lens body 432-1, or the lens body 532-1 while a second side of the lens body 132-1, the lens body 232-1, the lens body 332-1, the lens body 432-1, or the lens body 532-1 opposite to the first side, is disposed at the threaded hole 1230-2. Additionally, the lens 132, the lens 232, the lens 332, the lens 432, or the lens 532 eliminates a gap between the lens body 132-1, the lens body 232-1, the lens body 332-1, the lens body 432-1, or the lens body 532-1 and the rim 1230-1 in response to rotating the lens 132, the lens 232, the lens 332, the lens 432, or the lens 532 within the threaded hole 1230-2, such that the plurality of receiving threads 1230-3 receive the plurality of threads 132-3, the thread 232-3, the plurality of threads 332-3, the plurality of threads 432-3, or the plurality of threads 532-3. Accordingly, material of any of the lens body and/or any of the edge fill the gap and eliminate the gap.

A locking member 1235 is disposed on the rim 1230-1. The locking member 1235 may implement or be implemented by aspects of the plurality of locking members 335 as described with reference to FIG. 7. For example, the locking member 1235 improves fit of the lens body 332-1 within the threaded hole 1230-2 where the thread 332-3 is tapered. In some embodiments, the locking member 1235 includes a detent, a pin, a snap, an adhesive (e.g., tape, glue), a clamp, and the like. Alternatively, in other embodiments, the locking member 1235 includes a magnet.

FIG. 13 illustrates the optical assembly 1300 projecting the display light toward a waveguide 1340 in accordance with some embodiments. The optical assembly 1300 includes an optical housing 1330, a plurality of lenses 1332, and a micro light-emitting diode (μLED) panel 1334. Each of the plurality of lenses 1332 may implement or be implemented by aspects of the lens 132, 232, 332, 432, and 532 as described with reference to FIGS. 1 through 9. The optical housing 1330 (used interchangeably with lens barrel 1330) may implement or be implemented by aspects of the lens barrel 130, 230, 330, 430, and 1230 as described with reference to FIGS. 3 through 8 and 12. In the depicted example, the u LED panel 1334 projects a display light 1350 toward a waveguide 1340. An incoupler 1341 couples the display light 1350 within the waveguide 1340.

The optical assembly 1300 may implement or be implemented by aspects of the optical assembly 120 as described with reference to FIG. 1. Accordingly, in some embodiments, the optical assembly 1300 is disposed within at least a portion of the first arm 104. The lens barrel 1330 receives and connects to each of the plurality of lenses 1332. Each of the plurality of lenses 1332 receives and reflects light, transmits light, shapes the path of the light, or any combination thereof. Specifically, the plurality of lenses 1332 collect the display light emitted from the u LED panel 1334. Moreover, the plurality of lenses 1332 focus and shape the display light 1350 toward the waveguide 1340.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A lens apparatus comprising:
a lens body configured to receive a display light; and
a thread disposed on at least a portion of the lens body, the thread configured to align and lock to a lens barrel in response to a partial rotation of the lens body, and redirect stray light contacting an interior surface of the thread with respect to a boundary between each surface of the thread, the stray light to exit through an exterior surface of the thread with respect to an environment surrounding the lens body and the thread.

2. The lens apparatus of claim 1, wherein the thread comprises:
a cam profile comprising grooves and interlocking threads.

3. The lens apparatus of claim 1, wherein the thread is disposed from a first side of the lens body to a second side of the lens body opposite the first side of the lens body.

4. The lens apparatus of claim 1, wherein the thread comprises:
a discontinuous thread-form on the exterior surface of the lens body, the discontinuous thread-form including a plurality of facets.

5. The lens apparatus of claim 4, wherein each of the plurality of facets of the discontinuous thread-form is disposed differently from each other facet of the plurality of facets with respect to a perpendicular axis to the plurality of facets.

6. The lens apparatus of claim 4, wherein each of the plurality of facets redirects the stray light through the thread based on an angle of orientation of each of the plurality of facets.

7. The lens apparatus of claim 1, further comprising:
at least one locking member disposed on the lens body or the thread and configured to connect to the thread or the lens body, respectively.

8. The lens apparatus of claim 7, wherein the at least one locking member connects to the thread or the lens body based on a centration threshold and a radial orientation threshold such that the lens body is centered in response to connecting to the at least one locking member.

9. A method comprising:
connecting a lens within an optical assembly; and
locking the lens to the optical assembly in response to at least partially rotating the lens within the optical assembly based on a cam profile.

10. The method of claim 9, wherein rotating the lens within the optical assembly in a first rotational direction or a second rotational direction substantially eliminates a gap between the lens and an inner surface of the optical assembly.

11. The method of claim 9, wherein locking the lens to the optical assembly comprises connecting a thread of the lens to a lens barrel of the optical assembly.

12. The method of claim 9, wherein locking the lens to the optical assembly comprises:
connecting at least one locking member to a surface of the optical assembly; and
preventing movement of the lens within the optical assembly in response to the at least one locking member contacting the surface of the optical assembly.

13. The method of claim 12, wherein the at least one locking member is at least one of a detent, a pin, or a snap.

14. The method of claim 12, wherein connecting the at least one locking member to the surface of the optical assembly is based on at least one centration threshold and at least one radial orientation threshold.

15. An optical assembly comprising:
a lens apparatus, comprising:
a lens body; and
a thread disposed on at least a portion of the lens body configured to redirect stray light from an interior of the lens body with respect to a boundary between each surface of the thread, the stray light to exit through an exterior of the lens body with respect to an environment surrounding the lens body and the thread;
an optical housing configured to receive the thread and align and lock to the thread in response to a partial rotation of the lens body therein; and
a micro light-emitting diode panel configured to emit a display light toward the lens apparatus.

16. The optical assembly of claim 15, wherein the optical housing comprises:
a thread receiving groove configured to threadably receive the thread in response to rotation of the thread within the optical housing.

17. The optical assembly of claim 15, wherein the optical housing comprises:
at least one locking member configured to prevent movement of the thread within the optical housing in response to the at least one locking member contacting at least one of the thread and the lens body.

18. The optical assembly of claim 17, wherein the at least one locking member is at least one of a detent, a pin, or a snap.

19. The optical assembly of claim 17, wherein the at least one locking member connects to the thread or the lens body based on at least one centration threshold and at least one radial orientation threshold such that the lens body is centered in response to connecting to the thread or the lens body.

20. The optical assembly of claim 15, wherein receiving the thread within the optical housing in a first rotational direction or a second rotational direction substantially eliminates a gap between the lens body and an inner surface of the optical housing.
